(19) United States
(12) Patent Application Publication
(10) Pub. No.: US 2025/0024319 A1
(43) Pub. Date: Jan. 16, 2025

(54) SYSTEMS AND METHODS FOR USER EQUIPMENT ASSISTED BUFFER SIZE IN MULTI- CONNECTIVITY

(71) Applicant: Telefonaktiebolaget LM Ericsson (publ), Stockholm (SE)

(72) Inventors: Mårten ERICSON, Gammelstad (SE); Patrik RUGELAND, Bromma (SE)

(21) Appl. No.: 18/714,838

(22) PCT Filed: Dec. 2, 2021
(86) PCT No.: PCT/SE2021/051192

§ 371 Date: May 30, 2024

(51) Int. Cl. H04W 28/02

(52) U.S. Cl. CPC H04W 28/0278

(57) ABSTRACT

A method is provided for signalling memory requirements for an uplink buffer. The method is by a wireless device with multi-connectivity to a network node and includes receiving, from the network node, information that indicates a maximum buffer size of the uplink buffer of the wireless device.

### TECHNICAL FIELD

The present disclosure relates, in general, to wireless communications and, more particularly, systems and methods for user equipment-assisted buffer size in multi-connectivity.

### BACKGROUND

Dual connectivity (DC) was introduced in Release 12 (Rel-12) and is defined for intra-Evolved Universal Terrestrial Radio Access (intra-EUTRA) in 3GPP TS 36.300. See, TS 36.300 v16.3.0, Evolved Universal Terrestrial Radio Access (E-UTRA) and Evolved Universal Terrestrial Radio Access Network (E-UTRAN); Overall description; Stage 2. FIG. 1 illustrates the control plane (C-plane) and user plane (U-plane) connectivity of eNodeBs (eNBs) involved in DC. Both Master eNB (MeNB) and Secondary eNB (SeNB) are E-UTRA nodes, with an Evolved Packet Core (EPC) core network (CN) entity.

In 3GPP TS 37.340, DC is further defined for Multi-Radio Dual Connectivity (MR-DC), which was introduced in Release 15 (Rel-15). See, 3GPP TS 37.340 v16.3.0, Evolved Universal Terrestrial Radio Access (E-UTRA) and NR; Multi-connectivity; Stage 2. According to MR-DC, a user equipment (UE) is configured to connect to two different nodes. One provides E-UTRA access, and the other provides New Radio (NR) access. The CN entity associated to MR-DC can be either EPC or 5^{th} Generation Core (5GC), which divides MR-DC cases as follows:
E-UTRA-NR Dual Connectivity (EN-DC), comprised in EPS, as a master node (MN) E-UTRA eNB and an NR en-gNB as a secondary node (SN) (en-gNB refers to a NR gNodeB (gNB) that is operating in a non-standalone mode operating as the SN);
NG-RAN E-UTRA-NR Dual Connectivity (NGEN-DC), comprised in 5^{th} Generation System (5GS), as a MN ng-eNB (ng-eNB refers to E-UTRA eNB connected to 5GC) and an NR gNB as the SN;
NR-E-UTRA Dual Connectivity (NE-DC), comprised in 5GS, as a MN NR gNB and an E-UTRA ng-eNB as the SN;
NR-NR Dual Connectivity (NR-DC), comprised in 5Gs, as NR gNBs as both the MN and the SN.

A gNB or ng-eNB are collectively referred to as NG-RAN nodes.

FIG. 2 illustrates C-plane and U-plane connectivity for the EN-DC case. FIG. 3 illustrates C-plane and U-plane connectivity for the MR-DC case associated with 5GC.

In MR-DC, a data radio bearer (DRB) can be terminated in either the MN or the SN and be transmitted via either the master cell group (MCG) at the MN and/or via the secondary cell group (SCG) at the SN. FIG. 4 illustrates network side protocol termination options for MCG, SCG and split bearers in MR-DC with EPC (EN-DC). FIG. 5 illustrates network side protocol termination options for MCG, SCG and split bearers in MR-DC with 5GC (NGEN-DC, NE-DC, and NR-DC). Specifically, there are MN and SN terminated MCG and SCG bearers as well as MN and SN terminated split bearers (which are transmitted via both the MCG and SCG). For signaling radio bearers (SRBs) only MN terminated MCG bearers (SRB1, SRB2, SRB4), MN terminated split bearers (SRB1 and SRB2) and SN terminated SCG bearer (SRB3) are allowed.

The decision to add a SN and create a DC (EN-DC, LTE DC, NGEN-DC, NE-DC or NR-DC) connection to the UE is (typically) based on the UE reports measurement results. The network can configure the UE with different measurements such as, for example, the A4 event when a neighbor cell becomes better than a threshold or the A3 event when a neighbor becomes x dB better than serving node. The network then configures the UE to add the secondary node. If a split DRB is used the MN then splits the Packet Data Convergence Protocol (PDCP) packets it receives from the User Plane Function (UPF) between the MN and SN. In the UE, the PDCP packets are put into a buffer. This buffer orders the packet so that the upper layer (application layers) receives the PDCP packets in order. Therefore, the buffer is called the reordering buffer.

According to 3GPP TS 38.306 [0], the UE is required to provide a total layer 2 buffer size for reordering. See, 3GPP TS 38.306 v16.2.0, NR; User Equipment (UE) radio access capabilities. The total layer 2 buffer size is defined as the sum of the number of bytes that the UE is capable of storing in the Radio Link Control (RLC) transmission windows and RLC reception and reordering windows and also in PDCP reordering windows for all radio bearers.

The required total layer 2 buffer size in MR-DC and NR-DC is the maximum value of the calculated values based on the following equations:

MaxULDataRate_MN*RLCRTT_MN+MaxULDataRate_SN*RLCRTT_SN+MaxDLDataRate_SN*RLCRTT_SN+MaxDLDataRate_MN*(RLCRTT_SN+X2/Xn delay+Queuing in SN)

MaxULDataRate_MN*RLCRTT_MN+MaxULDataRate_SN*RLCRTT_SN+MaxDLDataRate_MN*RLCRTT_MN+MaxDLDataRate_SN*(RLCRTT_MN+X2/Xn delay+Queuing in MN)

Otherwise, it is calculated by:

MaxDLDataRate*RLC RTT+MaxULDataRate*RLC RTT.

It may be noted that additional Layer 2 (L2) buffer required for preprocessing of data is not taken into account in above formula.

The required total L2 buffer size is determined as the maximum total L2 buffer size of all the calculated ones for each band combination and the applicable Feature Set combination in the supported MR-DC or NR band combinations. The RLC Round Trip Time (RTT) for NR cell group corresponds to the smallest subcarrier spacing (SCS) numerology supported in the band combination and the applicable Feature Set combination.

An example of realistic (maximum) delays is given below:
X2/Xn delay+Queuing in SN=25 ms if SCG is NR, and 55 ms if SCG is EUTRA
X2/Xn delay+Queuing in MN=25 ms if MCG is NR, and 55 ms if MCG is EUTRA
RLC RTT for EUTRA cell group=75 ms
   RLC RTT for NR cell group is defined in Table 1, which corresponds to Table 4.1.4-1 3GPP TS 38.306:

TABLE 1

| | |
|---|---|
| SCS (KHz) | RLC RTT (ms) |

| | | |
|---|---|---|
| 15 | KHz | 50 |
| 30 | KHz | 40 |
| 60 | KHz | 30 |
| 120 | KHz | 20 |

By calculating the maximum throughput for NR using a 400 MHz BW, 120 kHz SCS, 8 carriers, 8 Multi Input Multi Output (MIMO) layers and 256QAM, a maximum (peak) bit-rate of 275 Gbps per path is determined. This may be inserted into the buffer size equations provided above. Using 25 ms as delay (NR), results in a L2 buffer of 18 Gbit (2 GB).

In data networks, packets of a data stream may reach their destination via multiple paths. A routing function at a “splitting point” has to decide which packets shall take which path. A flow-control algorithm may be provided which has the aim to ensure that a receiver at the destination can deliver “reordered data” as fast as possible to an application using the data.

A multiple RX TX UE in RRC_CONNECTED is configured to utilize radio resources provided by two distinct schedulers, located in two e/gNBs connected via a non-ideal backhaul over the Xn/X2 interface.

For the transport of user plane data from the UPF or the S-GW to the UE, so-called “split bearers” may be used. Split bearers provide two paths for downlink user plane data. They can either be sent from the UPF/S-GW via a MN/MeNB to the UE, or they can be sent from the S-GW via the MeNB to a SN/SeNB which finally sends them to the UE. For a “split bearer” the MN is U-plane may be connected to the SN via N5/S1-U and in addition, the MN is interconnected to a SN via Xn-U/X2-U.

The routing function in the PDCP layer of the MN/MeNB decides whether a PDCP layer PDU of a split bearer is sent directly over the local air interface to the UE or whether it is forwarded to the SN via X2-U. A PDCP layer reordering function in the UE receives PDUs from the MN and from the SN, reorders them and forwards them to the application running on the UE.

At least for LTE-internal split-bearer operation, the purpose of the X2-U Downlink data delivery status procedure is to provide feedback from the SN to the MN to allow the MN to control the downlink user data flow via the SN for the respective E-RAB. According to previous techniques and methods, when the SN decides to trigger the Feedback for Downlink Data Delivery procedure, it shall report:
a) the highest PDCP PDU sequence number successfully delivered in sequence to the UE among those PDCP PDUs received from the MN;
b) the desired buffer size in bytes for the concerned radio bearer;
c) the minimum desired buffer size in bytes for the UE; and
d) the X2-U packets that were declared as being “lost” by the SN and have not yet been reported to the MN within the DL DATA DELIVERY STATUS frame.

Certain previous reporting techniques enable the eNB to determine failures of packets transmitted over Wi-Fi, the WLAN-branch throughput, and the amount of data queued for the bearer in WLAN. These techniques keep overhead tolerable while allowing an efficient flow control when feedback from WLAN is not available. As e/gNB knows the sizes of the PDCP PDUs sent via WLAN, it can easily calculate the throughput over Wi-Fi air interface adding up the sizes of acknowledged packets and dividing it by the time elapsed from the last status report. The amount of data queued in WLAN for one bearer is easily calculated as the difference between the cumulated size of packets already sent over Wi-Fi and the cumulated size of acknowledged packets.

Additionally, certain previous reporting techniques trigger the creation of a flow control report that includes information of at least one of a highest count value of protocol data units received over a particular wireless link and protocol data units not received so far. The protocol data units not received so far are limited to protocol data units with count values falling within a range of count values determined using preconfigured rules. The method provide for communicating the flow control report between a user equipment and a base station.

In the flow control report, an upper end of the range of count values is based on a highest count value of protocol data units received over a particular wireless link. A lower end of the range of count values is based on at least one of a count value of a first missing protocol data unit and an upper end of a count-value range that a most recent previously sent report was limited to. An upper end of the count-value range covered in a previously sent report is stored as a packet data convergence protocol state variable, and the triggering the creation of the flow control report is based on an increase in at least one of a highest count value of a protocol data unit received over a particular wireless link, a value of a first missing segment, and a number of protocol data units received over the particular wireless link since a most previous flow control report. The triggering of the creation of the flow control report is based on a received packet data convergence protocol service data unit delivered to upper layers when no received service data units remain stored. The flow control report can be sent after an expiration of a status-prohibit timer.

Certain problems exist, however. For example, the DC splitting function in PDCP tries to estimate the rate on each path based on flow control feedback and split traffic accordingly. FIG. 6 illustrates an example of the flow control problem with a bad SN path. As illustrated, the MN PDCP flow-control sends a Packet Data Unit (PDU) at time ti to the SN. At the same time, the MN transmits several PDU packets t₂-t₁₀. These paths can have different and varying characteristics (e.g. link rate, congestion, latency). Thus, it may be difficult for the MN PDCP flow-control to know how much data it can send to the SN at any given time. Due to the delays, the flow-control feedback may be invalid.

Further, due to the fact that the PDCP PDUs are delivered in-order for most services, the total latency will be dictated by the worst path. If packets are sent down the wrong path, this will increase the total delay further and can lead to packet losses due to limited reordering capabilities in the UE (governed by tReorderingDlPdcp) as the UE is required to wait for the outstanding data packets before it can forward them to the higher layers.

To handle the delays described above, the UE L2 re-ordering buffer size must be dimensioned for this (as calculated according to 3GPP TS 38.306 described above). However, the UE L2 re-ordering buffer size will be even larger for 6^{th} Generation (6G) since the peak bitrate will probably increase at least ten-fold compared to 5G. Furthermore, UE vendors may be unwilling to invest in enough memory to support the needed reordering for high rate DC. In other words, they may simply ignore the UE L2 re-ordering buffer size requirement.

Additionally, the required L2 reordering buffer size in 3GPP TS 38.306 assumes that all data traffic should be possible to send via split bearers. However, in many cases, the UE may be configured with a multitude of bearers, some of which are split, and some of which are only transmitted via the MCG or the SCG. If the UE implements a small L2 reordering buffer, then it would have to limit its maximum throughput in either the MN or the SN to not exceed the requirements for the L2 reordering bugger size, even though the UE can still be configured with no split bearers.

Also, there is no way for the UE to share the memory between different parts in the UE since 3GPP TS 38.306 stipulates the exact amount of memory required for the L2 buffer. Therefore, it is not currently possible for the UE to select the L2 buffer size based on its current memory situation. For example, assume that a UE is using a lot of memory for one application and at the same time need to perform DC with another non-demanding application. As it is now, the UE still needs to allocate a very large L2 buffer for the DC connection since it is not currently possible for the UE to select how to optimize its memory usage.

### SUMMARY

To address the foregoing problems with existing solutions, disclosed are systems and methods enabling UE-assisted buffer size in multi-connectivity. Specifically, systems and methods are provided enabling the network to have knowledge about the UE reordering buffer size, while at the same time, allowing the UE to have a flexible reordering buffer size.

According to certain embodiments, a method is provided for signalling memory requirements for an uplink buffer. The method is by a wireless device with multi-connectivity to a network node and includes receiving, from the network node, information that indicates a maximum buffer size of the uplink buffer of the wireless device.

According to certain embodiments, a wireless device with multi-connectivity to a network node is adapted to receive, from the network node, information that indicates a maximum buffer size of an uplink buffer of the wireless device.

According to certain embodiments, a method by a network node for signalling memory requirements for an uplink buffer of a wireless device with multi-connectivity to the network node includes estimating a maximum buffer size of the uplink buffer of the wireless device. The network node sends, to the wireless device, information that indicates the maximum buffer size of the uplink buffer of the wireless device.

According to certain embodiments, a network node is provided for signalling memory requirements for an uplink buffer of a wireless device with multi-connectivity to the network node. The network node is adapted to estimate a maximum buffer size of the uplink buffer of the wireless device and send, to the wireless device, information that indicates the maximum buffer size of the uplink buffer of the wireless device

Certain embodiments of the present disclosure may provide one or more technical advantages. For example, a technical advantage provided by certain embodiments may include enabling better flow control for a multi connectivity solution. Another technical advantage provided by certain embodiments may include the UE providing information to the NW of the UE's buffer size capabilities such that the network may adapted the amount of data that is sent to the different MC paths and avoid overflow of the UE buffer. This may in turn prevent packet errors. Still another advantage may be that certain embodiments may enable the UE to adapt the memory it uses for a transmission, allowing low-cost UEs to implement a small and thus cheaper, memory, instead of over-provisioning the memory based on the worst-case scenario. If the smaller memory begins to fill up, the UEs can reduce the throughput to avoid memory overflow. For more expensive UEs, the buffer memory can be larger and thus avoid the need to reduce the throughput when the buffer begin to increase. As still another advantage certain embodiments may enable the UE to select to use more memory for certain demanding applications and less for other applications (and save memory for other applications).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the C-plane and U-plane connectivity of eNBs involved in DC;

FIG. 2 illustrates C-plane and U-plane connectivity for the EN-DC case;

FIG. 3 illustrates C-plane and U-plane connectivity for the MR-DC case associated with 5GC;

FIG. 4 illustrates network side protocol termination options for MCG, SCG and split bearers in EN-DC;

FIG. 5 illustrates network side protocol termination options for MCG, SCG and split bearers in NGEN-DC, NE-DC, and NR-DC;

FIG. 6 illustrates an example of the flow control problem with a bad SN path;

FIG. 7 illustrates an example method by a network for adapting to ULE reordering buffer capabilities, according to certain embodiments;

FIG. 8 illustrates an example method by a network for estimating and providing information relating to the UE buffer needs, according to certain embodiments;

FIG. 9 illustrates an example communication system, according to certain embodiments;

FIG. 10 illustrates an example UE, according to certain embodiments;

FIG. 11 illustrates an example network node, according to certain embodiments;

FIG. 12 illustrates a block diagram of a host, according to certain embodiments;

FIG. 13 illustrates a virtualization environment in which functions implemented by some embodiments may be virtualized, according to certain embodiments;

FIG. 14 illustrates a host communicating via a network node with a UE over a partially wireless connection, according to certain embodiments;

FIG. 15 illustrates a method for signalling memory requirements for an uplink buffer, according to certain embodiments; and

FIG. 16 illustrates a method performed by a network node 110A-B for signalling memory requirements for an uplink buffer of a wireless device with multi-connectivity to the network node, according to certain embodiments.

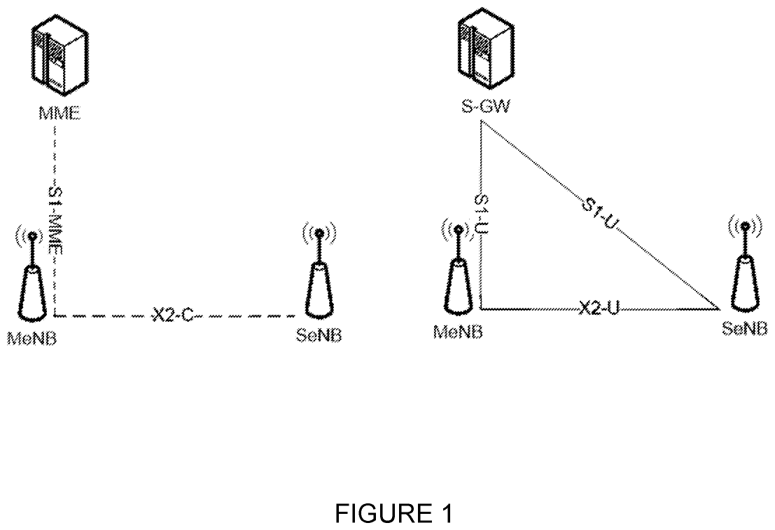

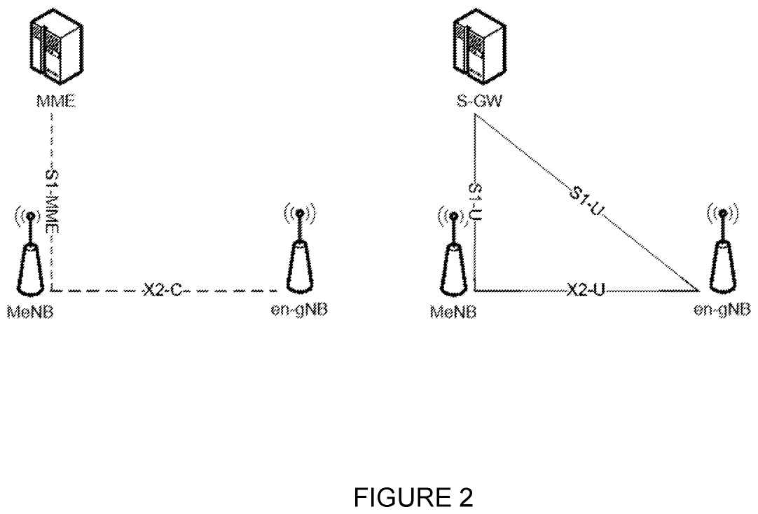

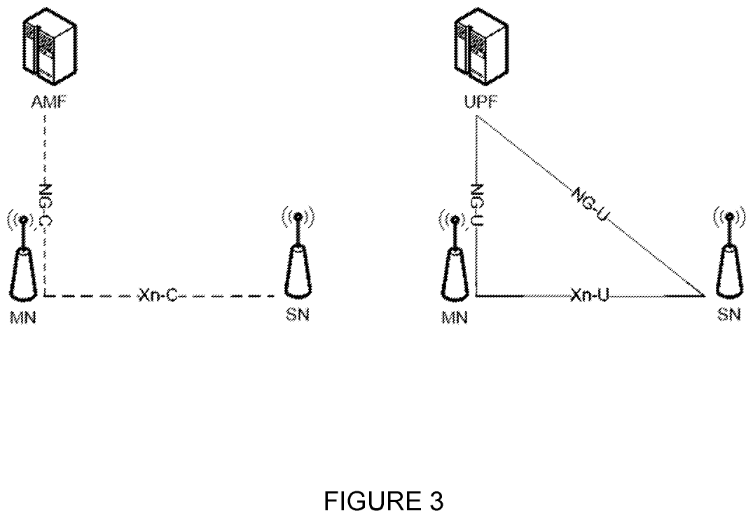

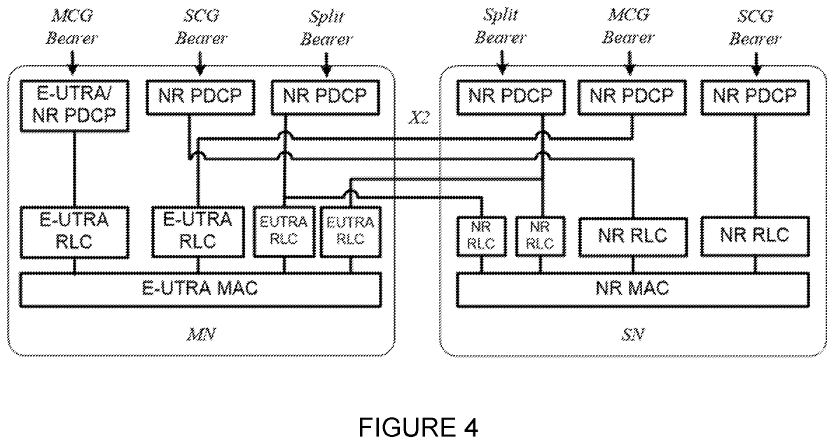

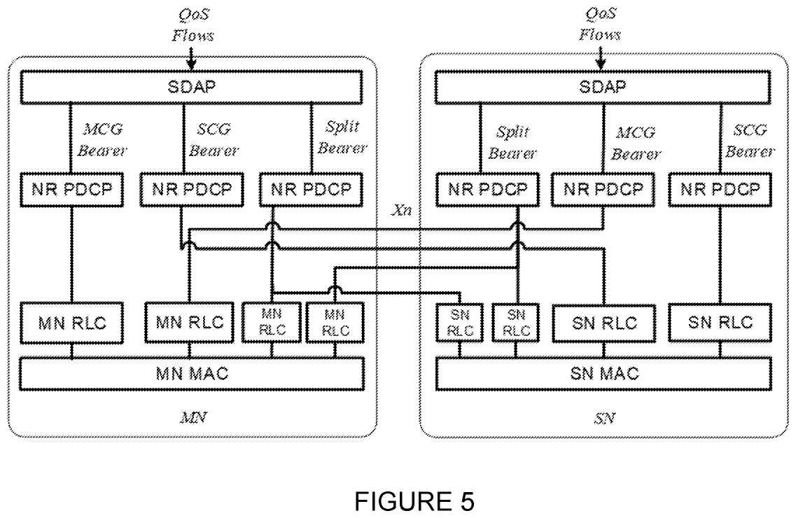

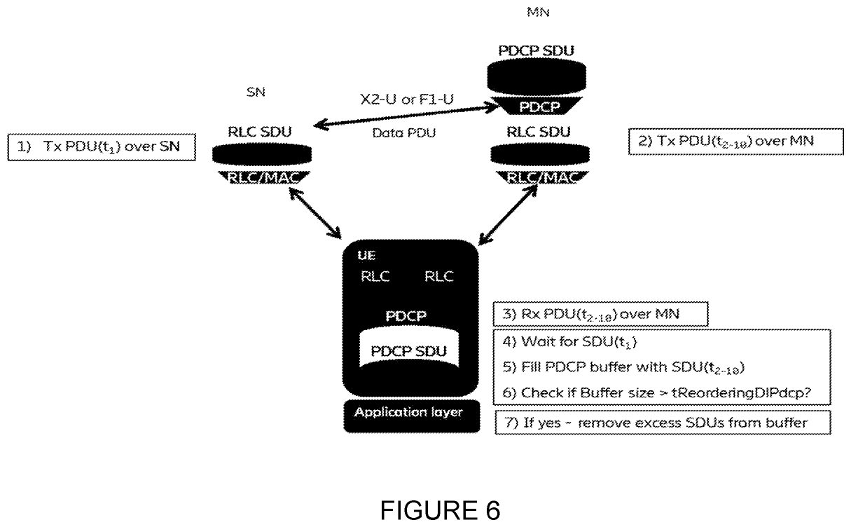

### DETAILED DESCRIPTION

Particular embodiments of the present disclosure may provide solutions enabling UE-assisted buffer size in multi-connectivity. Certain embodiments may include functionality for providing a network with information relating to the size of a reordering buffer of a UE. As such, the network may optimize the throughput to the UE on each path. Additionally, certain embodiments may allow the UE to have a flexible reordering buffer size such that the UE may select to use more memory for certain demanding applications and less memory for other applications that are less demanding.

The aspects described herein are described using the NR-NR DC framework, but is equally applicable to LTE-DC, EN-DC, NE-DC; NGEN-DC and NE-DC as well as possible multi-connectivity options involving more than two paths.

Though certain embodiments are described in terms of MN terminated split bearers transmitted via the MCG and the SCG, the solutions are equally applicable in case of SN terminated split bearers transmitted via the MCG and SCG, or in case of more than two paths, an MN, SN1, SN2, etc. terminated bearer transmitted via any 2 or more paths.

Certain embodiments assume that the UE is configured to deliver the PDCP packets in-order. This is the typical case since most services requires this.

According to certain embodiments, a method may include:
1. The network configures split bearer for UE in DC or MC and applies flow control.
2. When the bearers are setup, the network may estimate the UE buffer size needs for the UE based on used application or estimated throughput needs.
3. The UE can then also send (or respond) the UE reorder buffer size capabilities to the network.
   The “handshake” can occur when the network request this or after the network has sent its them or when the SCG is setup. This has the advantage that the network can optimize the transmission based on this, i.e. decrease or increase the throughput compared to the default buffer size calculation defined in 3GPP TS 38.306.

In certain embodiments, if the network does not receive any response from the UE after requesting the information relating to the capability of the UE, the network may assume that the UE supports the default buffer size defined in 3GPP TS 38.306.

According to certain other embodiments, if the network does not send UE buffer size needs to the UE and the UE does not send any UE buffer size capability, the network may assume the default buffer size calculation defined in 3GPP TS 38.306. As such, when the UE is not utilizing the full L2 buffer size, the memory may be used for other purposes, i.e. a smaller part of the UE memory needs to be reserved for the reordering. Stated differently, the UE can now focus either on the current very memory consuming gaming app or on the UE buffer size to support the DC transmission speed. This also allows phone vendors the flexibility to make cheaper (or more expensive) phones.

### Optimized UE Reordering Buffer Capabilities

In 6G, the peak throughout is expected to increase significantly compared to current generations. At the same time, 6G will employ more fragile radio links at higher carrier frequencies. These links may be susceptible to blockage and sudden throughput drops. As such, even a temporary drop in throughput on one path will quickly fill up the UE reordering buffer from the other path. Since UE vendors may be unwilling to invest in vast buffers that mainly sit unused, a UE may instead drop packets due to buffer overflow. This may result in a service interruption.

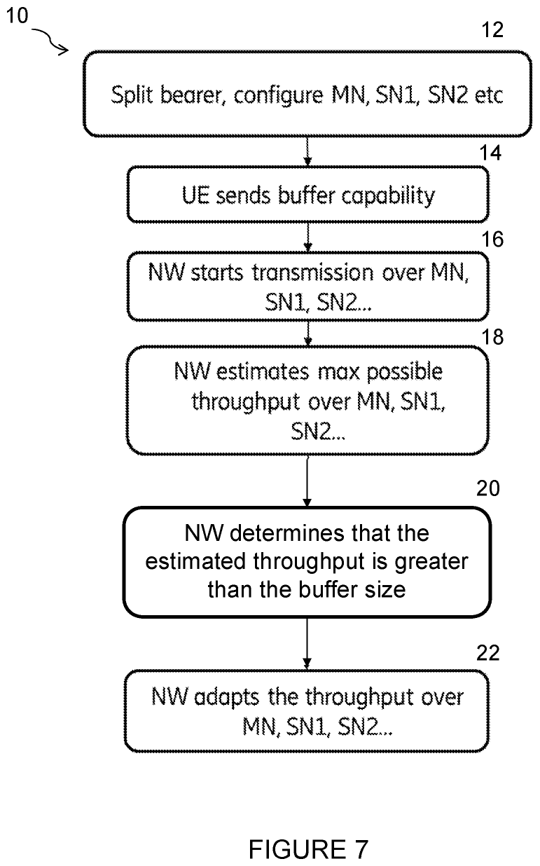

According to certain embodiments described herein, however, methods, systems, and mechanisms are provided for estimating the UE buffer needs by the network. For example, FIG. 7 illustrates an example method 10 for adapting to UE reordering buffer capabilities. As illustrated in FIG. 7, the method begins at step 12 when the network configures split bearer for the UE in DC or MC and applies flow control. At step 14, the UE sends the UE reorder buffer size capabilities to the network when the SCG is setup. At step 16, the network starts transmission over MN, SN1, SN2, etc. Specifically, in certain embodiments, the transmission may be optimized based on the UE reorder buffer size capabilities. For example, the network may lower or raise the throughput of a transmission based on the UE reorder buffer size capabilities.

At step 18, the network estimates the maximum possible throughput over MN, SN1, SN2, etc. In other words, the network estimates amount of data transmitted via MCG and SCG(s) and informs the UE so the UE can reserve enough memory for the buffer. This can be sent either when setting up the SCG(s) or in a later message. In a particular embodiment, for example, the estimated throughput can be per path (e.g. MCG: X Gbps, SCG1: Y Gbps, SCG2: Z Gbps) or a ratio of the total received throughput per path (e.g. MCG: X %, SCG1: Y %; SCG2: Z %).

At step 20, the network determines that the estimate throughput is higher than the UE reorder buffer size capabilities. The network then adapts the amount of data sent to the different paths in order to avoid overflowing the buffer, at step 22.

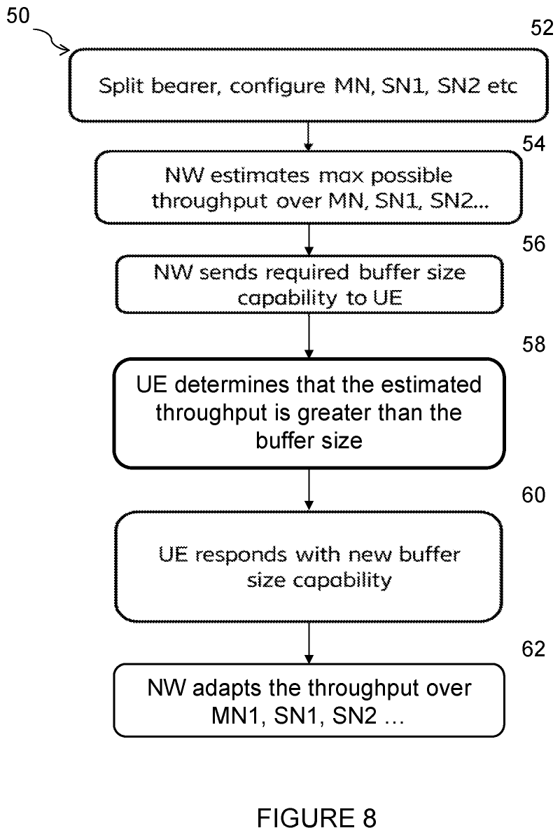

According to certain other embodiments, the NW can also send the needed UE buffer capacity to the UE. In this case, the NW can estimate the UE buffer needs and inform the UE about these and the UE can respond with a correct buffer size capability. FIG. 8 illustrates an example method 50 by the network for estimating the UE buffer needs and informing the UE about these UE buffer needs. The NW may inform the UE both at SCG setup and during transmission (if something changes).

As illustrated in FIG. 8, the method begins at step 52 when the network configures split bearer for the UE in DC or MC for MN, SN1, SN2, etc. At step 54, the NW estimates the maximum possible throughput over MN, SN1, SN2, etc. At step 56, the network sends the required buffer size capability to the UE so the UE can reserve enough memory for the buffer. This can be sent either when setting up the SCG(s) or in a later message. In a particular embodiment, for example, the estimated throughput can be per path (e.g. MCG: X Gbps, SCG1: Y Gbps, SCG2: Z Gbps) or a ratio of the total received throughput per path (e.g. MCG: X %, SCG1: Y %; SCG2: Z %).

At step 58, the UE determines that the estimate throughput is greater than the UE reorder buffer size capabilities. The UE may then respond with a correct buffer size capability, at step 60. The network then adapts the amount of data sent to the different paths in order to avoid overflowing the buffer, at step 62.

The NW may estimate the UE buffer needs in many different ways. For example, in various particular embodiments, the NW may estimate the UE buffer needs and/or capabilities as follows:
a. UE reordering buffer size in total
b. UE reordering buffer size per path
c. Estimated throughput per path (e.g. MCG: X Gbps, SCG1: Y Gbps, SCG2: Z Gbps)
   i. the UE can calculate the buffer needs from these parameters and in addition be prepared for
d. Since this ratio could fluctuate quickly, this value could be given as a range, e.g. MCG X1-X2 Gbps/SCG Y1-Y2 Gbps.
e. Estimated throughput range per path (e.g. MCG: X1-X2 Gbps, SCG1: Y1-Y2 Gbps, SCG2: Z1-Z2 Gbps); or
f. Estimate ratio of total throughput per path (e.g. MCG: X %, SCG1: Y %; SCG2: Z %)
g. Estimated ratio range of total throughput per path (e.g. MCG: X1-X2%, SCG1: Y1-Y2%, SCG2: Z1-Z2%)

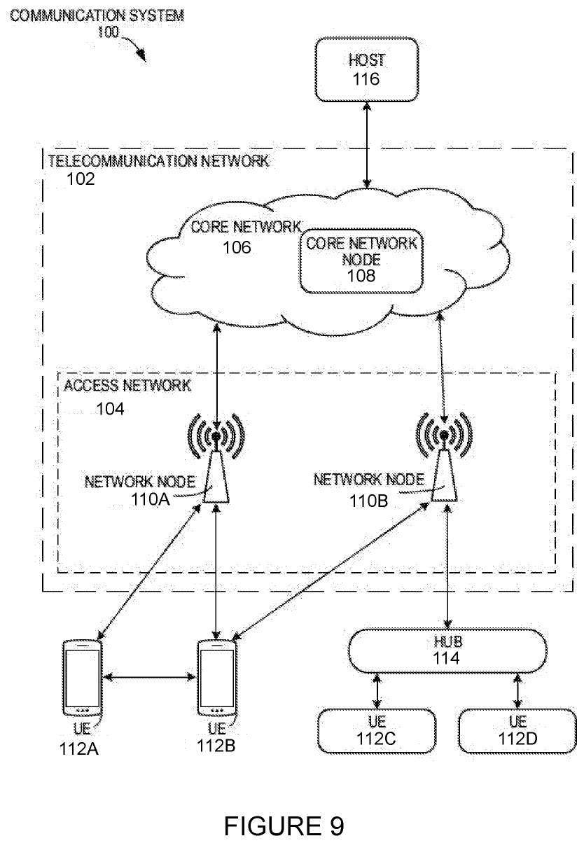

FIG. 9 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a ULE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

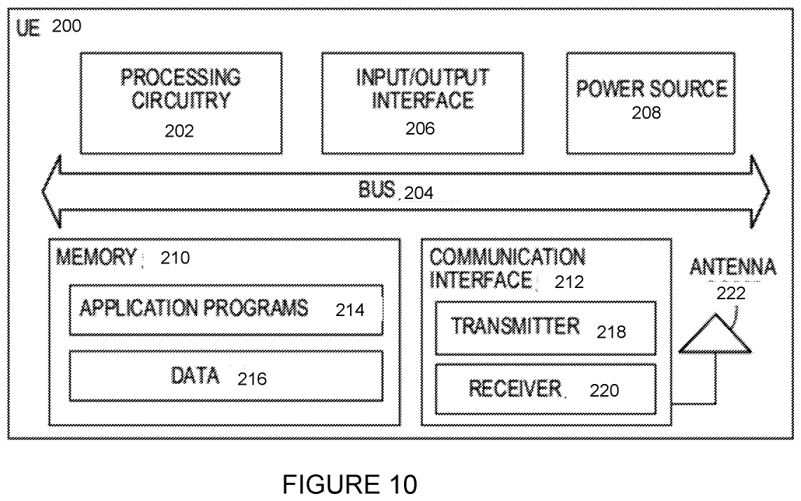

FIG. 10 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

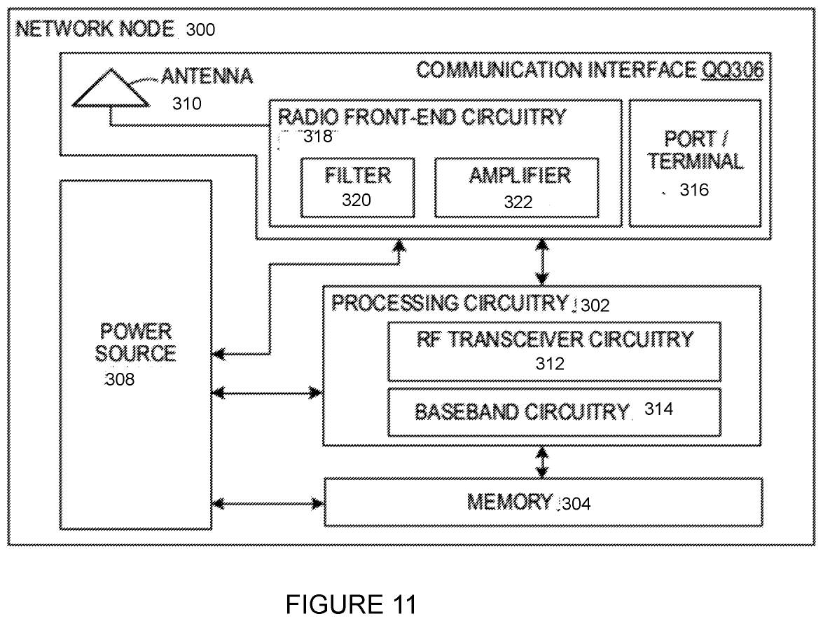

FIG. 11 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

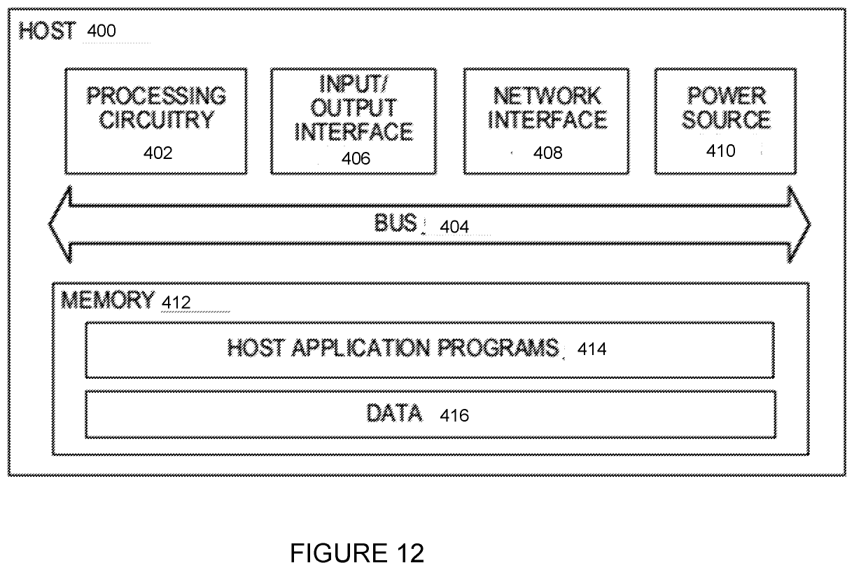

FIG. 12 is a block diagram of a host 400, which may be an embodiment of the host 116 of FIG. 9, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 11, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

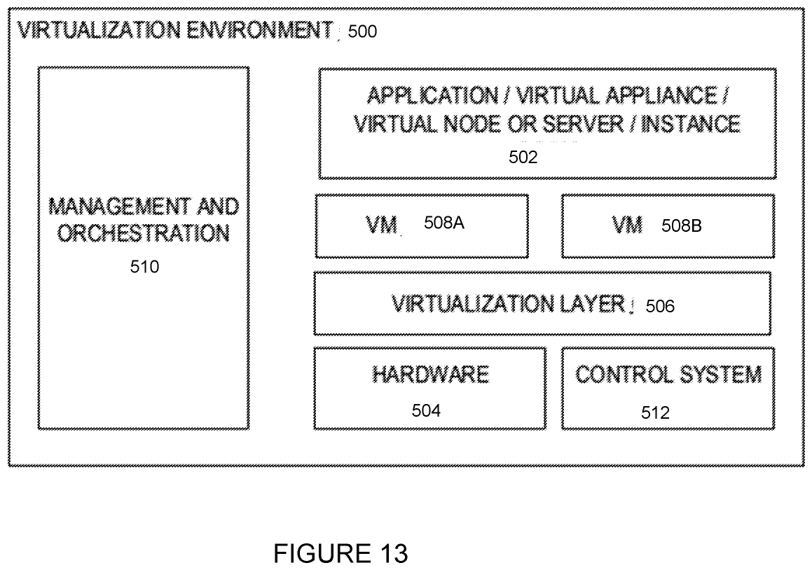

FIG. 13 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources.

As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth.

Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

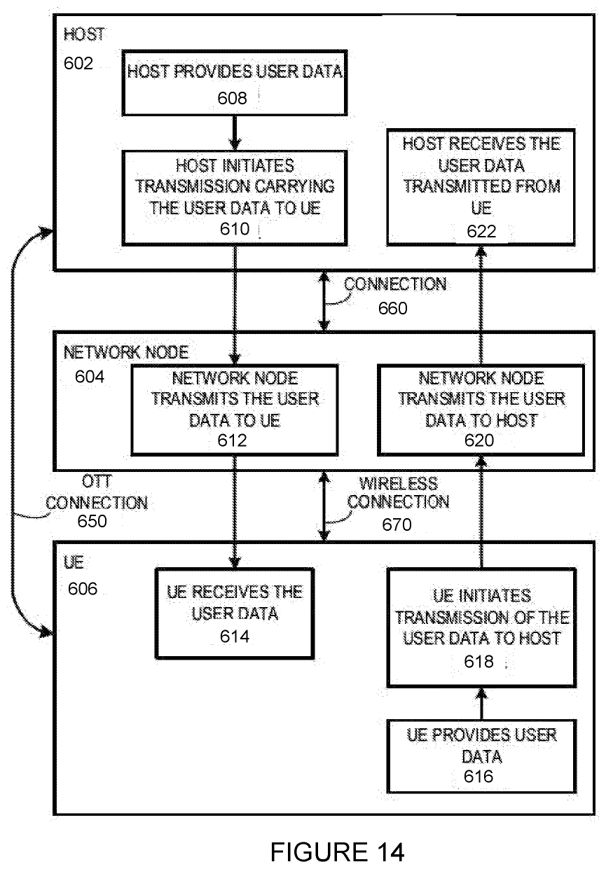

FIG. 14 shows a communication diagram of a host 602 communicating via a network node 604 with a UE 606 over a partially wireless connection in accordance with some embodiments.

Example implementations, in accordance with various embodiments, of the UE (such as a UE 112a of FIG. 9 and/or UE 200 of FIG. 10), network node (such as network node 110a of FIG. 9 and/or network node 300 of FIG. 11), and host (such as host 116 of FIG. 9 and/or host 400 of FIG. 12) discussed in the preceding paragraphs will now be described with reference to FIG. 14.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 9) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

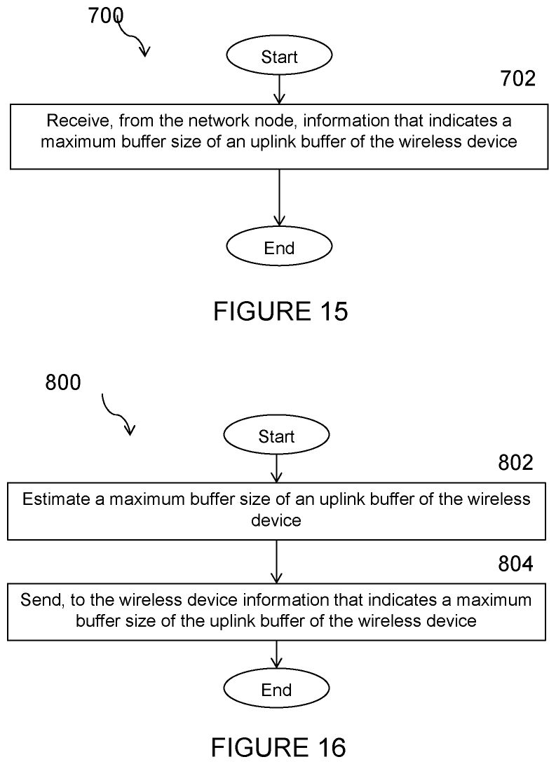

FIG. 15 illustrates a method 700 for signalling memory requirements for an uplink buffer, according to certain embodiments. The method is performed by a wireless device 112A-D with multi-connectivity to a network node 110A-B. The method includes receiving, from the network node 110A-B, information that indicates a maximum buffer size of the uplink buffer of the wireless device 112A-D.

In a particular embodiment, the wireless device 112A-D determines that the maximum buffer size is not acceptable and transmits, to the network node 110A-B, an updated maximum reordering buffer of the wireless device 112A-D.

In a particular embodiment, the wireless device 112A-D allocates memory within the uplink buffer to at least one packet reordering operation based on the maximum buffer size.

In a further particular embodiment, the wireless device 112A-D determines that at least a portion of the memory within the uplink buffer will not be used for the at least one packet reordering operation. The wireless device 112A-D allocates the portion of the memory that will not be used for the at least one packet reordering operation to at least one other operation.

In a particular embodiment, the wireless device 112A-D receives, from the network node 110A-B, a request for the maximum buffer size. The maximum buffer size is transmitted to the network node 110A-B after receiving the request for the maximum buffer size.

In a particular embodiment, the maximum buffer size comprises a total number of bytes or a total number of packets that the uplink buffer of the wireless device 112A-D is capable of storing.

In a particular embodiment, the maximum buffer size comprises a number of bytes or a number of packets for at least one of a plurality of paths between the wireless device and the network node.

In a particular embodiment, the maximum buffer size comprises an estimated throughput for at least one of a plurality of paths between the wireless device 112A-D and the network node 110A-B. In a further particular embodiment, the estimated throughput comprises a range of estimated throughput for the at least one of the plurality of paths between the wireless device 112A-D and the network node 110A-B.

In a particular embodiment, the maximum buffer size comprises a ratio of a total throughput for at least one of a plurality of paths between the wireless device 112A-D and the network node 110A-B. In a further particular embodiment, the ratio of the total throughput comprises a ratio range of the total throughput for the at least one of the plurality of paths between the wireless device and the network node.

In a further particular embodiment, the plurality of paths comprise two or more of any combination of: a NR path, a LTE path, and an 6G RAN path.

FIG. 16 illustrates a method 800 performed by a network node 110A-B for signalling memory requirements for an uplink buffer of a wireless device 112A-D with multi-connectivity to the network node 110A-B. The method begins at step 802 when the network node 110A-B estimates a maximum buffer size of the uplink buffer of the wireless device. At step 804, the network node 110A-B sends, to the wireless device 112A-D, information that indicates the maximum buffer size of the uplink buffer of the wireless device 112A-D.

In a particular embodiment, the network node 110A-B receives, from the wireless device 112A-D, an updated maximum buffer size. The network node 110A-B adapts at least one transmission parameter of the network node 110A-B based on the updated maximum buffer size. In a further particular embodiment, the network node 110A-B applies a throughput per path based on the updated maximum buffer size.

In a further particular embodiment, the network node 110A-B transmits at least one signal to the wireless device 112A-D based on the updated maximum buffer size.

In a particular embodiment, the network node 110A-B transmits, to the wireless device 112A-D, an allocation of memory within the uplink buffer. The allocation of memory is for performing at least one packet reordering operation based on the maximum buffer size. In a further particular embodiment, the network node 110A-B determines that at least a portion of the memory within the uplink buffer will not be used by the wireless device 112A-D for the at least one packet reordering operation. The network node 110A-B transmits, to the wireless device 112A-D, an indication that the portion of the memory that will not be used for the at least one packet reordering operation.

In a particular embodiment, the network node 110A-B transmits, to the wireless device 112A-D, a request for the maximum buffer size, and the maximum buffer size is received from the wireless device 112A-D after the request for the maximum buffer size is transmitted to the wireless device 112A-D.

In a particular embodiment, when estimating the maximum buffer size, the network node 110A-B determines a total number of bytes or a total number of packets that the reordering buffer of the wireless device 112A-D is capable of storing.

In a particular embodiment, when estimating the maximum buffer size, the network node 110A-B determines a number of bytes or a number of packets for at least one of a plurality of paths between the wireless device 112A-D and the network node 110A-B.

In a particular embodiment, when estimating the maximum buffer size, the network node 110A-B determines at least one estimated throughput for at least one of a plurality of paths between the wireless device 112A-D and the network node 110A-B.

In a further particular embodiment, the at least one estimated throughput comprises a range of estimated throughputs for the at least one of the plurality of paths between the wireless device and the network node.

In a particular embodiment, when estimating the maximum buffer size, the network node 110A-B determines a ratio of a total throughput for at least one of a plurality of paths between the wireless device 112A-D and the network node 110A-B.

In a particular embodiment, the ratio of the total throughput comprises a range of ratios of total throughput for the at least one of the plurality of paths between the wireless device 112A-D and the network node 110A-B.

In a particular embodiment, the plurality of paths comprise two or more of any combination of: a NR path, an LTE path, and an 6G RAN path.

In a particular embodiment, the network node 110A-B sends, to the wireless device 112A-D, at least one transmission and estimates a maximum possible throughput based on the at least one transmission sent to the wireless device 112A-D.

In a particular embodiment, the network node 110A-B determines that the estimated maximum possible throughput is greater than the maximum buffer size of the uplink buffer of the wireless device 112A-D and adapts at least one transmission parameter of the network node 110A-B.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method for signalling memory requirements for an uplink buffer, the method performed by a wireless device with multi-connectivity to a network node, the method comprising:
receiving, from the network node, information that indicates a maximum buffer size of the uplink buffer of the wireless device.

2. The method of claim 1 further comprising:
determining that the maximum buffer size is not acceptable, and
transmitting, to the network node, an updated maximum reordering buffer of the wireless device.

3. The method of claim 1, further comprising:
allocating memory within the uplink buffer to at least one packet reordering operation based on the maximum buffer size;
determining that at least a portion of the memory within the uplink buffer will not be used for the at least one packet reordering operation; and
allocating the portion of the memory that will not be used for the at least one packet reordering operation to at least one other operation.

4. (canceled)

5. The method of claim 1, wherein the maximum buffer size comprises a total number of bytes or a total number of packets that the uplink buffer of the wireless device is capable of storing.

6. The method of claim 1, wherein the maximum buffer size comprises a number of bytes or a number of packets for at least one of a plurality of paths between the wireless device and the network node, wherein the plurality of paths comprise two or more of any combination of:
a New Radio, NR, path,
a Long Term Evolution, LTE, path, and
an 6G RAN path.

7. (canceled)

8. A method performed by a network node for signalling memory requirements for an uplink buffer of a wireless device with multi-connectivity to the network node, the method comprising:
estimating a maximum buffer size of the uplink buffer of the wireless device; and
sending, to the wireless device, information that indicates the maximum buffer size of the uplink buffer of the wireless device.

9. The method of claim 8, further comprising:
receiving, from the wireless device an updated maximum buffer size; and
adapting at least one transmission parameter of the network node based on the updated maximum buffer size.

10. The method of claim 9, further comprising applying a throughput per path based on the updated maximum buffer size.

11. The method of claim 9, further comprising transmitting at least one signal to the wireless device based on the updated maximum buffer size.

12. The method of claim 8, further comprising transmitting, to the wireless device, an allocation of memory within the uplink buffer, the allocation of memory for performing at least one packet reordering operation based on the maximum buffer size.

13. The method of claim 12, further comprising:
determining that at least a portion of the memory within the uplink buffer will not be used by the wireless device for the at least one packet reordering operation; and
transmitting, to the wireless device, an indication that the portion of the memory that will not be used for the at least one packet reordering operation.

14. The method of claim 8, wherein estimating the maximum buffer size comprises determining a total number of bytes or a total number of packets that the reordering buffer of the wireless device is capable of storing.

15. The method of claim 8, wherein estimating the maximum buffer size comprises determining a number of bytes or a number of packets for at least one of a plurality of paths between the wireless device and the network node.

16. The method of claim 8, wherein estimating the maximum buffer size comprises determining at least one estimated throughput for at least one of a plurality of paths between the wireless device and the network node.

17. The method of claim 16, wherein the at least one estimated throughput comprises a range of estimated throughputs for the at least one of the plurality of paths between the wireless device and the network node.

18. The method of claim 8, wherein estimating the maximum buffer size comprises determining a ratio of a total throughput for at least one of a plurality of paths between the wireless device and the network node.

19. The method of claim 18, wherein the ratio of the total throughput comprises a range of ratios of total throughput for the at least one of the plurality of paths between the wireless device and the network node.

20. The method of claim 15, wherein the plurality of paths comprise two or more of any combination of:
a New Radio, NR, path,
a Long Term Evolution, LTE, path, and
an 6G RAN path.

21. The method of claim 8, further comprising:
sending, to the wireless device, at least one transmission to the wireless device; and
based on the at least one transmission sent to the wireless device, estimating a maximum possible throughput.

22. The method of claim 21, further comprising:
determining that the estimated maximum possible throughput is greater than the maximum buffer size of the uplink buffer of the wireless device; and
adapting at least one transmission parameter of the network node.

23. A wireless device with multi-connectivity to a network node, the wireless device adapted to:
receive, from the network node, information that indicates a maximum buffer size of the uplink buffer of the wireless device.

24.-29. (canceled)

30. A network node for signalling memory requirements of an uplink buffer of a wireless device with multi-connectivity to the network node, the network node adapted to:
estimate a maximum buffer size of the uplink buffer of the wireless device; and
send, to the wireless device, information that indicates the maximum buffer size of the uplink buffer of the wireless device.

31.-44. (canceled)
